(19) United States
(12) Patent Application Publication
(10) Pub. No.: US 2007/0168201 A1
(43) Pub. Date: Jul. 19, 2007

(54) Formula for automatic prioritization of the business impact based on a failure on a service in a loosely coupled application

(76) Inventor: Sudhakar Velkanthan Chellam, Apex, NC (US)

Correspondence Address: DILLON & YUDELL LLP, 8911 N. CAPITAL OF TEXAS HWY., SUITE 2110, AUSTIN, TX, 78759, US

(21) Appl. No.: 11/327,148

(22) Filed: Jan. 6, 2006

(51) Int. Cl. G06Q 99/00

(52) U.S. Cl. 705/1

(57) ABSTRACT

A method, apparatus and computer-usable medium for dynamically and deterministically evaluating the priority to assign to fixing a failed service for a business process comprising multiple independent services. A monitoring service of a computer system monitors the process and dynamically detects one or more failed services among the existing services. When the one or more failed services is detected, a failure prioritization utility executing on the computer system automatically determines a level of importance of each failed service within the business process and then prioritizes the one or more failed services relative to each other based on the determined level of importance. Finally, the failure prioritization utility generates and issues a signal to a system administrator of the priority order for addressing/fixing the one or more failed service(s) to minimize the negative impact on the business process of the failed services.

### BACKGROUND OF THE INVENTION

The present invention relates in general to the field of computers and similar technologies, and in particular to software utilized in this field.

Services Oriented Architecture (SOA) and reusable services are quickly becoming common in computer and business enterprises. SOA is an approach to software implementation where systems are composed of reusable components (referred to as “services”). A service is a software building block that performs a distinct function—such as retrieving customer information from a database—through a well-defined interface.

SOA organizes information resources as substantially independent, reusable services that create an inherently adaptable environment. Business and technical services may be published using open, standard protocols that create self describing services that can be used independently of the underlying technology. Technical independence allows services to be more easily used in different contexts to achieve standardization of business processes, rules and policies. Collaborations, internal and external to an enterprise, can more easily be established enabling improvements in process and information consistency.

### SUMMARY OF THE INVENTION

The present invention includes, but is not limited to, a method, apparatus and computer-usable medium for dynamically and deterministically evaluating the priority to assign to fixing a failed service on a business process comprising multiple independent services. A connected monitoring service of a computer system monitors the process and dynamically detects one or more failed services among multiple existing services of the business process. When the one or more failed services is detected, a failure prioritization utility executing on the computer system automatically determines a level of importance of each failed service within the business process and then prioritizes the one or more failed services relative to each other based on the determined level of importance. Finally, the failure prioritization utility generates and issues a signal to a system administrator of the priority order for addressing/fixing the one or more failed service(s) to minimize the negative impact on the business process of the failed services.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 illustrates an exemplary computer system within which various processes of the invention may advantageously be implemented;

FIG. 2 is a flow chart of the process of monitoring services and determining a priority for repair of failed services according to one embodiment of the invention;

FIG. 3A is a block diagram representation of multiple interdependent services within a business process comprising a service oriented architecture according to one embodiment of the present invention;

FIGS. 3B and 3C illustrate the application of a priority formula to monitored data of multiple services and a table representing the priority results, in accordance with embodiments of the present invention; and

FIGS. 4A and 4B are flow diagrams illustrating the interactions with a message storage facility within the process of FIG. 3A according to embodiments of the invention.

### DETAILED DESCRIPTION OF THE PREFERRED EMBODIMENT

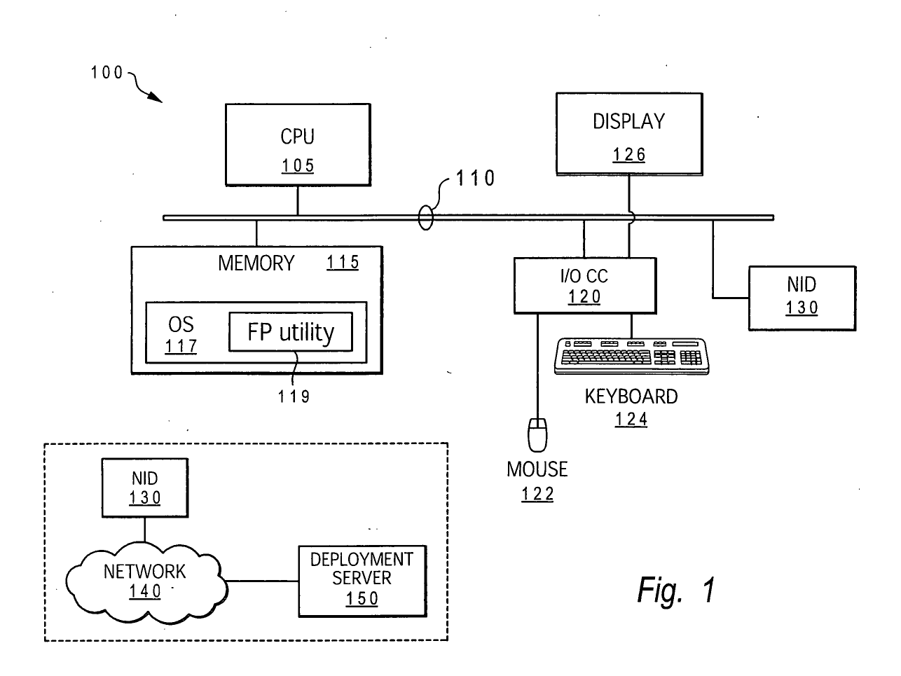

With reference now to the figures, and in particular to FIG. 1, there is depicted a computer system 100 within which various functional features of the invention may advantageously be implemented. Computer system 100 includes processor (central processing unit) 105, which is coupled to memory 115, input/output (I/O) controller 120 and network interface device (NID) 130 via system interconnect 110. NID 130 provides interconnectivity to an external network (not shown), through which one or more of the services that make up the business process may be monitored by a monitoring facility of computer system 100. I/O controller 120 provides connectivity to input devices, of which mouse 122 and keyboard 124 are illustrated, and output devices, of which display 126 is illustrated. Other components (not specifically illustrated) may be provided within/coupled to computer system 100. The illustration is thus not meant to imply any structural or other functional limitations on computer system 100 and is provided solely for illustration and description herein.

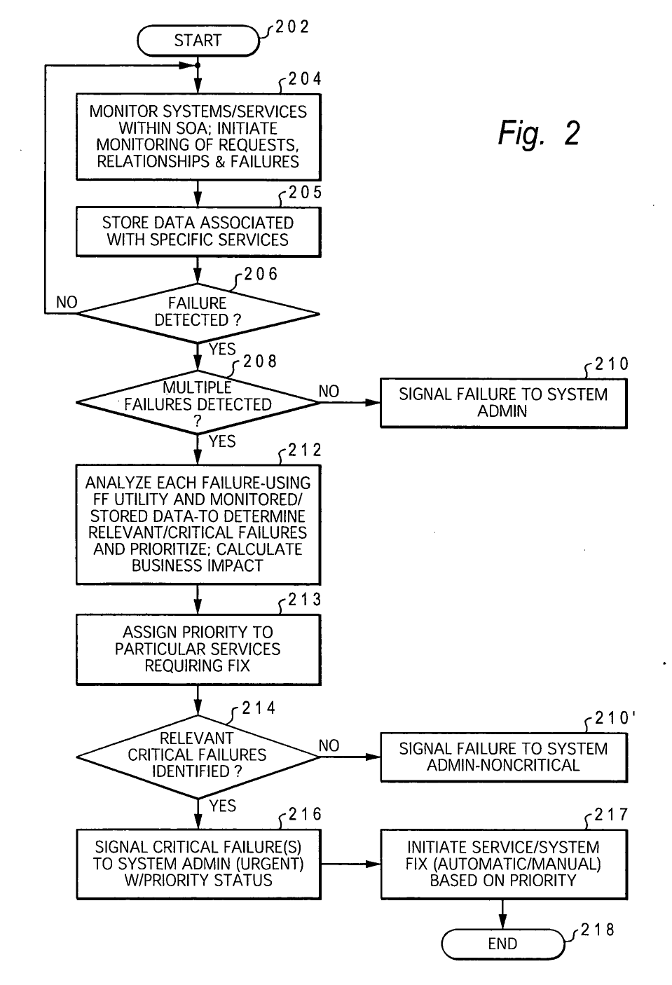

In addition to the above described hardware components of computer system 100, several software and firmware components are also provided within computer system 100 to enable computer system 100 to complete the process of monitoring various services and calculating priority of failed services, as described below. Among these software/firmware components are operating system (OS) 117 and Failure Prioritization (FP) algorithm/utility 119. FP utility 119 is illustrated as a separate component from memory 115. However, it is understood that, in alternate embodiments, FP utility 119 may be located on a removable computer readable medium or provided as a sub-component part of OS 117. When executed by processor 105, FP utility 119 executes a series of processes, which provide the various functions described below (referencing FIG. 2).

The present invention provides an automated process that includes collection of services data and application of a algorithmic function/formula to the collected data, to automatically prioritize the order of repair for services within a service oriented architecture (SOA) when multiple services fail. A brief discussion of SOA and the failure risks is now provided to establish the necessity for the present invention. As previously described, SOA provides a modular approach to computing. There is, however, a need to provide some sort of centralized control over the various services, which have varying degrees of importance to the overall SOA. When there are multiple services provided different levels of functionality to an overall process, some services are typically more critical (or essential) than others to the process. The level of essentialness of each service relative to each other within the particular process falls within a range from the least essential/critical to the most essential/critical. Each process defines the critical nature of a service differently. Thus, a service may be critical (essential) in a first business process but non-critical (non-essential) in another.

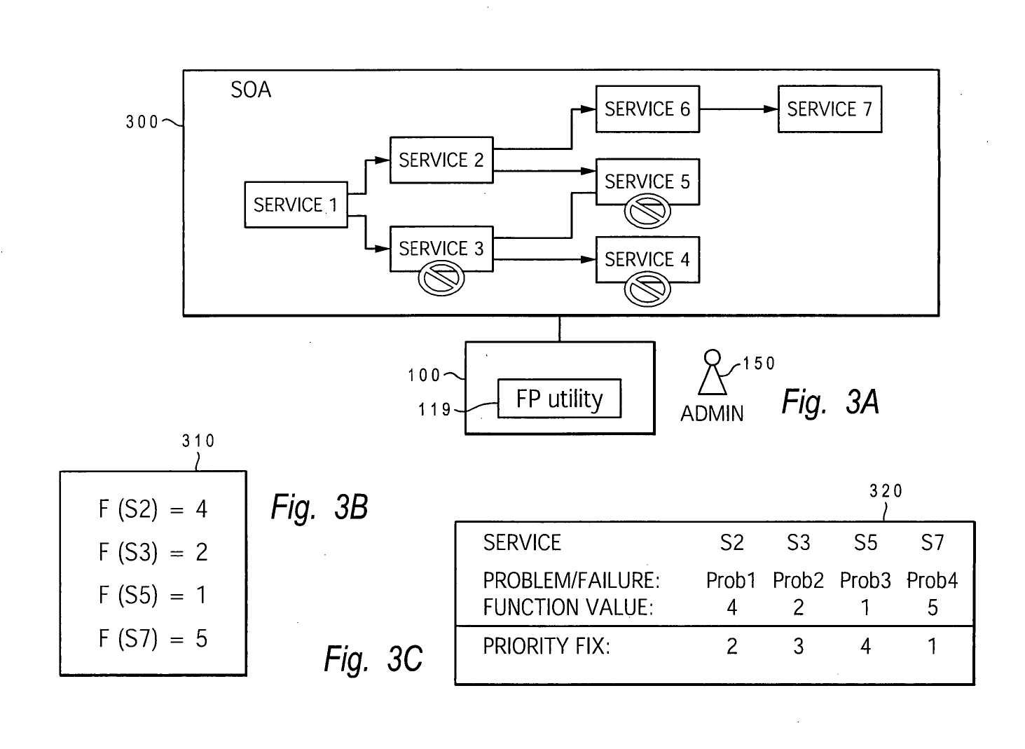

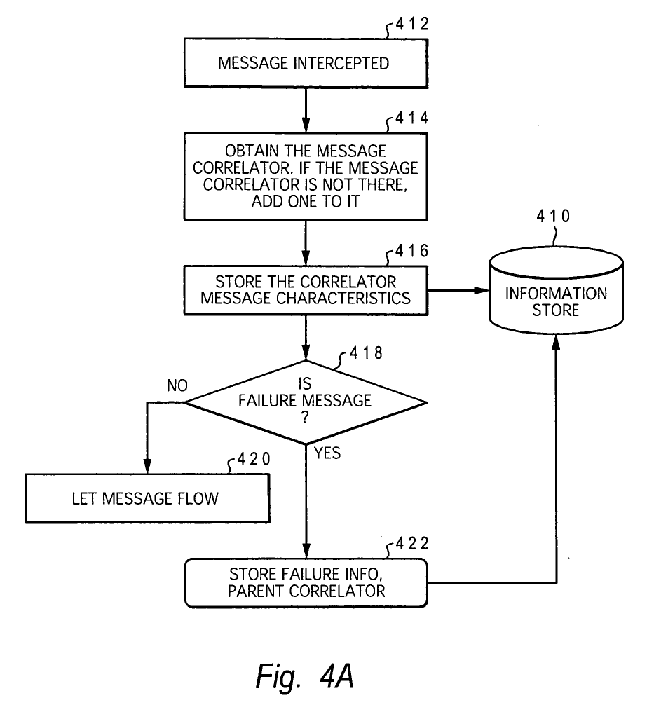

FIG. 3A generally illustrates a multiple-service business process 300 connected to a monitoring computer system 100 that comprises a FP utility 119 for utilization by a system/process administrator 150. As shown in business process 300, several of the services are interdependent, with one or more of the lower numbered service affected by failure of a higher number service. In the illustration, there are 3 services failing. Specifically, services S3, S4, and S5, have failed, indicated by a slash symbol marked across the service. With conventional methods, there is no way to detect the business impact of any one of these failed services. For example, the failure in S5 may not impact S2 because S2 is using S5 as a backup or a simple service. Alternatively, S5 may be a simple logging service. However, the failure to S4 and S5 may be impacting S3.

According to the invention, these failures are signaled to the computer system 100 via a network (not shown) to which the services (S1-S7) and computer system 100 are communicatively connected. Those skilled in the art are familiar with SOAs and the communication amongst services via Internet-based SOA, which includes a SOAP/HTTP protocol (i.e., a SOAP message protocol using an HTTP transport binding (e.g., remote procedure calls (RPCs) on a service provider by sending one message for each call).

As utilized within the illustrative embodiments, computer system 100 provides a centralized control point for managing the various services within a business process. The computer system (and system administrators that receive, analyze and respond to data there-from) is also responsible for ensuring that essential services are adequately maintained and administered.

When a failure occurs with any one or more of the services contributing to completion of a business process, each failure has some impact on the overall business process(es), some more critical than others. When multiple services fail simultaneously/concurrently, the end user or system administrator conventionally addresses each failure in the order of occurrence or some user-determined/random order. This is because, in conventional failure response methods, the administrator was unaware whether any of the failures are more critical to the business process(es) than another. When multiple failures occur simultaneously/concurrently, however, a substantial amount of time can be spent handling failures of non-critical or non-essential services while the more critical service remains in the failed state, negatively affecting the forward progress of the business process(es).

With convention methods, the business impact is evaluated by the transaction failure at any edge point, and the user has to define the edge point to define a failure. When the same services are utilized by the different applications, failure of the service might affect one application but not the other. By defining the edges, the user needs to understand the edge and configure events for the failures, and it is also impossible to prioritize the services.

The methods provided by the embodiments of the invention enable the FP utility to (1) automatically determine which of the one or more failures needs to be first addressed, and/or the order in which the failed services should be fixed and (2) signal the administrator (or end-user) of that order.

With reference now to the flow chart of FIG. 2, which illustrates the processing of the inventive methods, the process begins at initiator block 202 and continues to block 204, which illustrates a monitoring facility of the computer system/device monitoring the processes occurring via the various services within the SOA. The monitoring facility completes the monitoring of requests, relationships, and failures at the respective services. The collected information/data is then stored within a table associated with their specific services. The monitoring facility determines whether a failure has been detected at block 206. When no failure has been detected, the monitoring system continues to monitor the various services. When a failure has been detected, a next determination is made at block 208 whether there are multiple concurrent failures detected within the SOA. If only a single failure is detected, the FP utility signals the failure to the system administrator, as shown at block 210.

When multiple failures are detected, the FP utility analyzes each failure utilizing a priority function described below and stored data retrieved during monitoring of the system, as indicated at block 212. The priority function utilized in the illustrative embodiment is as follows:
I(s)=R(s)*Fs(S)*Σfp(RS).

The following legend applies to the above function:
S=service monitoring endpoint;
R=requests per second;
Fs=failure at service endpoints;
Fp=failure at the parent services;
I=impact to the business process; and
RS=related services.

Thus the priority of a service failure is calculated based on overall impact to the business process of the particular failure. The higher the value calculated, the greater the impact on the business, and the sooner this service failure should be addressed. Notably, by utilizing the above priority function, the system administrator does not need to define an edge point to define a failure or configure events for the failure whenever the same service is being utilized by different applications.

The above analysis determines the relevant/critical nature of the failure and prioritizes the multiple failures relative to each other (i.e., calculate the business impact of each failure). The FCP utility then assigns the calculated priority to the associated failed services at block 213.

According to the illustrative embodiment, the FCP utility then determines, at block 214, whether they are relevant or critical failures identified, and if not, the FCP utility signals the priority order of the failed service to the system administrator, identifying them as being non-critical. In the illustrative embodiment, a threshold impact value is defined by the system administrator to determine when a failure is critical. If the calculated impact is above this threshold value, then the failure is critical. Returning to the figure, if there are critical failures identified, the FCP utility signals the critical failures to the system administrator, at block 216, with an urgent message indicating the priority status of the particular services, whose failure are determined to be critical. Again, the order of priority of these critical failures is provided to the system administrator. According to the illustrative embodiment, receipt of a signal indicating a critical failure initiates a pre-ordering service/system fix/response based on the priority of the particular critical failures, as shown at block 217. The process then ends at terminator block 218.

FIG. 3B shows the application of the above formula to the data received/retrieved from the various failed services (block 310). Application of the formula to respective data produces a result associated with the service from which the data is received. To illustrate the application of the formula, a few assumptions are made within the example application of FIG. 3A. Among these assumptions are: (a) assume there are three requests per second coming in to S5; and (b) assume there is one request per second coming in to S4. Utilizing these assumption, the Impact of Failure at the S5 and S4 are calculated as:
I(S5)=3 * 1 * 0=0
I(S4)=1 * 1 * 1=1

The higher the calculated value, the greater the impact of the failure on the business. Thus, applying the above formula to the above example results in a determination that S4's failure is more important to be fixed than that of S5. One advantage of applying this formula to the determination of which failure should be prioritized is that even if though S5 is receiving more requests per second than S4, the impact of S5's failure on any of the parent services is less than the impact of S4.

FIG. 3C provides a table 320 with a tabulation of the priority results and associated services, according to one embodiment of the embodiment. As shown, once the priority values have been calculated, the values are tabulated in priority order so that the system administrator may schedule the fixes/repairs of the more critical services first. In one embodiment, an output is generated and transmitted to an output device of the computer system, indicating the correct ordered for fixing the list of failed services.

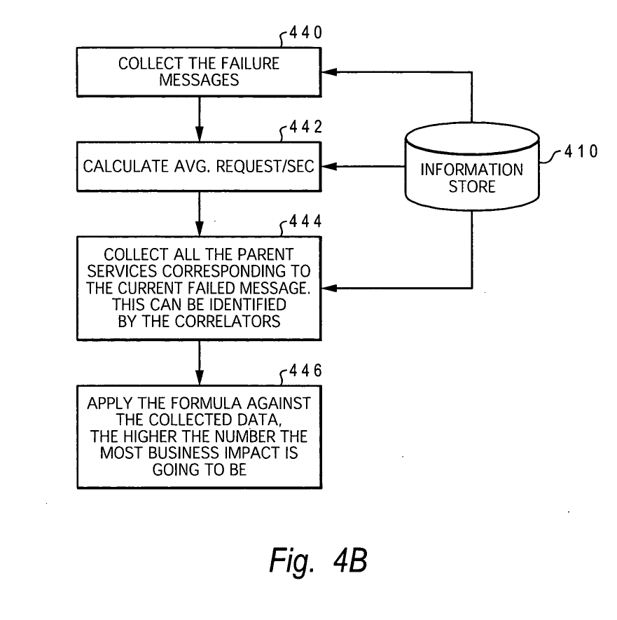

FIGS. 4A and 4B provide a different view of the process from the perspective of collecting and storing correlation data and eventually utilizing the stored data within the formula to determine which failed service should be given highest priority. The process steps are depicted by the figures, which also indicate the storage facility being utilized to store the data and then retrieve the data for utilizing within the priority calculation. The process of FIG. 4A begins at block 412 at which a message is intercepted. The message is checked for a message correlator, and if one is not found, a correlator is assigned to the message, as shown at block 414. The correlator message characteristics is then stored at block 416 within information store 410. Following a determination is made at block 418 whether the message is a failure messaged and if so, the failure information is stored along with the parent correlator, as shown at block 422. If the message is not a failure message, the message is permitted to flow, as indicated at block 420.

FIG. 4B begins at block 440 at which the failure messages are collected from information store 410. Then the average request per second is calculated for each service as shown at block 442. Following, all parent services corresponding to the failed messages (identified by the correlator information retrieved from information store 410) are collected at block 444, and the formula is applied against all the collected data at block 446. As also indicated within block 446, the higher the number from the calculation, the more the business impact is going to be for that service failure.

The embodiments of the invention are particularly effective and useful in SOA. With SOA, software applications may now be extensively re-used (where SOA technique is extremely powerful) and built only when necessary. Furthermore, in a SOA environment, the services come in many forms and shapes, and the implementation platforms and protocols utilized may be different.

It should be understood that at least some aspects of the present invention may alternatively be implemented in a computer-useable medium that contains a program product. Programs defining functions on the present invention can be delivered to a data storage system or a computer system via a variety of signal-bearing media, which include, without limitation, non-writable storage media (e.g., CD-ROM), writable storage media (e.g., a floppy diskette, hard disk drive, read/write CD ROM, optical media), and communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent. Thus, the method described herein, and in particular as shown and described in FIG. 2, can be deployed as a process software from service provider server 150 to client computer 100.

While the present invention has been particularly shown and described with reference to a preferred embodiment, it will be understood by those skilled in the art that various changes in form and detail may be made therein without departing from the spirit and scope of the invention. Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDA's), telephones, and any other system capable of processing, transmitting, receiving, capturing and/or storing data.

What is claimed is:

1. A computer-implementable method comprising:
dynamically detecting one or more failed services among multiple existing services of a business process;
when the one or more failed services is detected, automatically determining a level of importance of each failed service within the business process;
prioritizing the one or more failed services relative to each other based on the determined level of importance; and
signaling a system administrator of a priority order for addressing the one or more failed service to minimize the negative impact on the business process of the failed services.

2. The computer-implementable method of claim 1, wherein said detecting comprises monitoring the multiple existing services for an occurrence of a failure within the existing services, wherein said failure results in one of the existing services becoming one of the one or more failed services.

3. The computer-implementable method of claim 1, wherein said determining comprises:
calculating a priority level of each of the one or more failed services utilizing a priority function and data specific to the particular one of the one or more failed services;
providing a normalized result of a first calculation relative to a next result of each other calculation performed.

4. The computer-implementable method of claim 3, further comprising:
monitoring each of said multiple existing services for one or more of (a) number of requests, (b) frequency of requests, (c) relationships, and (d) failures;
storing the monitored data within a storage facility of the computer device; and
performing said calculating with the stored, monitored data.

5. The computer-implemented method of claim 4, further comprising:
defining an edge point for completing a business impact analysis of the failure of each of said one or more failed service; and
configuring the events monitored and data utilized within the priority calculation based on the edge point defined.

6. The computer implemented method of claim 1, wherein said multiple existing services are components associated to a service oriented architecture (SOA) that provides said business process.

7. A system comprising:
a processor;
a data bus coupled to the processor;
a memory coupled to the data bus; and
a computer-usable medium embodying computer program code, the computer program code comprising instructions executable by the processor and configured to:
dynamically detect one or more failed services among multiple existing services of a business process;
when the one or more failed services is detected, automatically determine a level of importance of each failed service within the business process;
prioritize the one or more failed services relative to each other based on the determined level of importance; and
signal a system administrator of a priority order for addressing the one or more failed service to minimize the negative impact on the business process of the failed services.

8. The system of claim 7, wherein said instructions for detecting are further configured to monitor the multiple existing services for an occurrence of a failure within the existing services, wherein said failure results in one of the existing services becoming one of the one or more failed services.

9. The system of claim 7, wherein said instructions for determining are further configured to:
calculate a priority level of each of the one or more failed services utilizing a priority function and data specific to the particular one of the one or more failed services;
provide a normalized result of a first calculation relative to a next result of each other calculation performed.

10. The system of claim 9, wherein the instructions are further configured to:
monitor each of said multiple existing services for one or more of (a) number of requests, (b) frequency of requests, (c) relationships, and (d) failures;
store the monitored data within a storage facility of the computer device; and
perform said calculating with the stored, monitored data.

11. The system of claim 10, wherein the instructions are further configured to:
define an edge point for completing a business impact analysis of the failure of each of said one or more failed service; and
configure the events monitored and data utilized within the priority calculation based on the edge point defined.

12. The system of claim 7, wherein said multiple existing services are components associated to a service oriented architecture (SOA) that provides said business process.

13. A computer-usable medium embodying computer program code, the computer program code comprising computer executable instructions configured to:
dynamically detect one or more failed services among multiple existing services of a business process;
when the one or more failed services is detected, automatically determine a level of importance of each failed service within the business process;
prioritize the one or more failed services relative to each other based on the determined level of importance; and
signal a system administrator of a priority order for addressing the one or more failed service to minimize the negative impact on the business process of the failed service.

14. The computer-usable medium of claim 13, wherein the embodied computer program code further comprises computer executable instructions configured to monitor the multiple existing services for an occurrence of a failure within the existing services, wherein said failure results in one of the existing services becoming one of the one or more failed services.

15. The computer-usable medium of claim 13, wherein the embodied computer program code further comprises computer executable instructions configured to:
calculate a priority level of each of the one or more failed services utilizing a priority function and data specific to the particular one of the one or more failed services;
provide a normalized result of a first calculation relative to a next result of each other calculation performed.

16. The computer-usable medium of claim 13, wherein the embodied computer program code further comprises computer executable instructions configured to:
monitor each of said multiple existing services for one or more of (a) number of requests, (b) frequency of requests, (c) relationships, and (d) failures;
store the monitored data within a storage facility of the computer device; and
perform said calculating with the stored, monitored data.

17. The computer-usable medium of claim 16, wherein the embodied computer program code further comprises computer executable instructions configured to:
define an edge point for completing a business impact analysis of the failure of each of said one or more failed service; and
configure the events monitored and data utilized within the priority calculation based on the edge point defined.

18. The computer implemented method of claim 13, wherein said multiple existing services are components associated to a service oriented architecture (SOA) that provides said business process.

19. The computer-useable medium of claim 13, wherein the computer executable instructions are deployable to a client computer from a server at a remote location.

20. The computer-useable medium of claim 13, wherein the computer executable instructions are provided by a service provider to a customer on an on-demand basis.
